(19) United States
(12) Patent Application Publication
(10) Pub. No.: US 2013/0205659 A1
(43) Pub. Date: Aug. 15, 2013

(54) METHOD OF CONTROLLING FUSARIUM VIGULIFORME AND SOYBEAN SUDDEN DEATH SYNDROME USING THIABENDAZOLE

(71) Applicant: Clifford Watrin, Minnetonka, MN (US)

(72) Inventor: Clifford Watrin, Minnetonka, MN (US)

(73) Assignee: SYNGENTA CROP PROTECTION LLC, Greensboro, NC (US)

(21) Appl. No.: 13/806,180

(22) PCT Filed: Jun. 23, 2011
(86) PCT No.: PCT/US11/41624

§ 371 Date: Mar. 8, 2013

Related U.S. Application Data
(60) Provisional application No. 61/358,451, filed on Jun. 25, 2010.

(51) Int. Cl. A01N 43/78; A01G 1/00

(52) U.S. Cl. CPC A01N 43/78; A01G 1/001
USPC 47/58.1 SE; 514/365

(57) ABSTRACT

The present technology relates to methods of controlling Fusarium virguliforme, Fusarium brasiliense sp. nov., Fursarium cuneirostrum sp. nov., Fusarium tucumaniae and Soybean Sudden Death Syndrome (SSDS) using thiabendazole. In one embodiment the present technology relates to methods of controlling Fusarium virguliforme and Soybean Sudden Death Syndrome (SSDS) using thiabendazole.

The present technology relates to methods of controlling Fusarium virguliforme, Fusarium brasiliense sp. nov., Fursarium cuneirostrum sp. nov., Fusarium tucumaniae and Soybean Sudden Death Syndrome (SSDS) using thiabendazole. In one embodiment the present technology relates to methods of controlling Fusarium virguliforme and Soybean Sudden Death Syndrome (SSDS) using thiabendazole

Thiabendazole is a benzimidazole fungicide commonly used to control certain types of mold (e.g. blue and grey molds) and blight.

Fusarium virguliforme, formally known as F. solani f. sp. glycines (Aoki et al., 2003), is a soybean pathogen affecting soybean roots, namely found in the North America, and which later develops into the disease Soybean Sudden Death Syndrome (SSDS). Likewise, Fusarium brasiliense sp. nov., Fursarium cuneirostrum sp. nov., Fusarium tucumaniae are known precursors to SSDS in other global regions, for example, South America.

Methods of controlling Fusarium virguliforme and subsequently SSDS are limited. Certain soybean seed varieties have proven somewhat tolerant to F. virguliforme and SSDS, however no known varieties are resistant enough to provide adequate disease control in commercial soybean crops. Various in-furrow and seed applied fungicides are also used combat the pathogens, but the pathogens have proven hard to control and no suitable chemical fungicide was previously known for its ability to adequately control or suppress F. virguliforme and SSDS.

The present technology provides for the control of F. virguliforme, F. brasiliense sp. nov., F. cuneirostrum sp. nov., F. tucumaniae and SSDS by applying the chemical thiabendazole to plant propagation material prior to sowing. The present technology also provides for the application of thiabendazole to the locus of the plant propagation material for the control of F. virguliforme, F. brasiliense sp. nov., F. cuneirostrum sp. nov., F. tucumaniae and SSDS. The present technology also provides for the application of thiabendazole to the soil where the plant propagation material has been, or will be, sown for the control of F. virguliforme, F. brasiliense sp. nov., F. cuneirostrum sp. nov., F. tucumaniae and SSDS, for example, as an in-furrow application.

Plant propagation material, as defined herein, encompasses both true seeds and plant propagation material. While plant propagation material encompasses true seeds, plant propagation material itself is commonly referred to as a seed and is defined as such herein. Most seed treatments are applied to true seeds, which have a seed coat surrounding an embryo. Seed treatments are also applied to plant propagation materials such as rhizomes, bulbs, corms or tubers.

The active ingredient may be used in unmodified form but is normally used in the form of compositions. It can be applied together with further carriers, surfactants or other application-promoting adjuvants customarily employed in formulation technology. Suitable carriers and adjuvants can be solid or liquid and are the substances ordinarily employed in formulation technology, e.g. natural or regenerated mineral substances, solvents, dispersants, wetting agents, tackifiers, thickeners, binders or fertilizers.

The active ingredient is conveniently formulated in known manner e.g. into emulsifiable concentrates, coatable pastes, directly sprayable or dilutable solutions, dilute emulsions, wettable powders, soluble powders, dusts, granules, or by encapsulation in e.g. polymer substances. As with the nature of the compositions, the methods of application, such as spraying, atomising, dusting, scattering, coating or pouring, are chosen in accordance with the intended objectives and the prevailing circumstances.

The present technology provides for the application of thiabendazole to a seed at a rate of from about 0.1 to about 100 g thiabendazole/100 kg seed. Additionally preferred rate ranges in (g thiabendazole)/(100 kg seed) include 0.5 to 50, 1 to 50, 1 to 25, 2.5 to 10, 5 to 15, 8 to 12, 2.5 to 7.5, 3-7.5, and 4-6. Additional preferred rate ranges in (g thiabendazole)/(100 kg seed) include 5 to 25, 10 to 25, 15 to 25, and 18-22.

### EXAMPLES

Soybean cultivars NK-529-J6 and NK-533-T4 where used for testing. Cultivar NK-529-J6 is labeled as partially resistant to SDS and cultivar NK-533-T4 is labeled susceptible to SDS (Syngenta Seeds, Minneapolis, Minn.). Thiabendazole fungicide seed treatment was applied to both cultivars at a rate of 5 g a.i./100 kg seed. A mefenoxam and fludioxonil combination fungicide seed treatment was also applied at a rate of 3.75 g a.i./100 kg seed and 2.5 g a.i./100kg seed, respectively. Three pathogenic isolates of F. virguliforme (Scherm et al., 1978) were used to inoculate grain sorghum (Sorghum bicolor (L.)) following the methods of Farris Neto et al. (2006). Isolates were grown on one third strength Difco Potato Dextrose Agar (PDA) growth medium. After 18 days, isolate growth on the PDA was divided into thirds and placed into a bag containing 2.27 kg of sorghum seed and allowed to incubate at room temperature for 15 days. Five experiments were conducted in a growth chamber. Each experiment was a randomized complete block design with eight replications. A 1:1 ratio of soil and sand medium was mixed together thoroughly, and steam sterilized at 121° C. for one hour. Upon sterilization of the soil medium 150 g of soil and 2.25 g of yellow cornmeal was weighed and mixed together for each conetainer. A spore suspension was prepared using 17 to 20 day old isolates of F. virguliforme grown on PDA media. Each isolate was aseptically flooded with sterilized, de-ionized water and scraped from the PDA plates causing the release of F. virguliforme spores. Each isolate was then strained through cheesecloth and mixed together to produce the spore suspension. Spore concentrations were determined using a hemacytometer, and concentrations were adjusted to produce 10 000 spores g soil⁻¹. After the spore concentration was determined the spore suspension was diluted to a volume of 13 ml of spore suspension per conetainer. The soil was then inoculated with the diluted spore suspension (Gongora-Canul and Leandro, 2007). Once the soil was inoculated, conetainers were filled level full with the inoculated soil, and then planted with two seeds of each variety by seed treatment combination (after emergence, thinned to one plant per conetainer) and placed in the growth chamber. Growth chambers were set at 17° C. for one week then changed to 24° C., and maintained for the remainder of the experiment. Growth chambers were set to 17° C. to help slow the germination of the soybean and therefore increase the probability for infection of F. virguliforme to take place (Gongora-Canul and Leandro, 2008). Each growth chamber was set to a 14/10 h light/dark photoperiod (Prasad et al., 2008).

Data collection for the growth chambers consisted of visual disease ratings of SDS symptom severity following the methods of Njiti et al. (1996). Visual disease ratings began 14 days after planting (DAP) of the experiment and then continued on a five day basis, until five visual disease assessments were made. Disease incidence was recorded as a presence/absence rating.

Sudden death syndrome disease severity averaged across five experimental
growth chamber runs.

Disease Severity (1-9*)

| Seed Treatment | NK-S33-T4 | NK-S29-J6 |
|---|---|---|
| Control | 1.65 | 1.28 |
| Mefenoxam + Fludioxonil¹ | 1.63 | 1.08 |
| Thiabendazole² | 1.08 | 0.96 |
| LSD (0.05) | 0.39 | |

*Sudden Death Syndrome disease severity rating scale following the methods of Njiti et al., (1996).
¹(2.5 g Fludioxonil/100 kg seed and 3.75 g Mefenoxam/100 kg seed)
²(5 g ai/100 kg seed)

Application of thiabendazole to NK-533-T4 resulted in a 35% reduction in disease severity. Application of thiabendazole to NK-S29-J6 resulted in a 25% reduction in disease severity. The level of reduction in disease severity was unexpected as SSDS was not previously known to be controlled by a chemical application or treatment.

Application of the combination of fludioxonil and mefenoxam to NK-29-J6 resulted in a 15.5% reduction in disease severity and a 1% reduction when applied to NK-533-T4.

The present technology can also be used in combination with other additional pesticides in order to increase the pest control spectrum. Other pesticides include, but are not limited to, insecticides, fungicides, nematicides, acaricides, molluscicides, and bacteriacides.

Suitable additions of insecticidally, acaricidally, nematicidally, or molluscicidally active ingredients are, for example and not for limitation, representatives of the following classes of active ingredients: organophosphorus compounds, nitrophenols and derivatives, formamidines, triazine derivatives, nitroenamine derivatives, nitro- and cyanoguanidine derivatives, ureas, benzoylureas, carbamates, pyrethroids, chlorinated hydrocarbons and Bacillus thuringiensis products. Especially preferred components in mixtures are abamectin, cyanoimine, acetamiprid, thiodicarb, nitromethylene, nitenpyram, clothianidin, dinotefuran, fipronil, lufenuron, pyripfoxyfen, thiacloprid, fluxofenime; imidacloprid, thiamethoxam, chlorantraniliprole, cyantraniliprole, spinosad, sulfloxaflor, beta cyfluthrin, lambda cyhalothrin, fenoxycarb, diafenthiuron, pymetrozine, diazinon, disulphoton; profenofos, furathiocarb, cyromazin, cypermethrin, tau-fluvalinate, tefluthrin or Bacillus thuringiensis products, very especially abamectin, thiodicarb, cyanoimine, acetamiprid, nitromethylene, nitenpyram, clothianidin, dinotefuran, fipronil, thiacloprid, imidacloprid, thiamethoxam, chlorantraniliprole, cyantraniliprole, spinosad, beta cyfluthrin, lambda cyhalothrin, and tefluthrin.

Preferred insecticidally, acaricidally, nematicidally, or molluscicidally active ingredients are, for example and not for limitation thiamethoxam, imidacloprid, thiacloprid, clothianidin, chloranthraniliprole, thiodicarb, abamectin, acetamidrprid, fipronil, tefluthrin, lambda cyhalothrin, and beta cyfluthrin Suitable additions of fungicidally active ingredients are, for example and not for limitation, representatives of the following classes of active ingredients: strobilurins, triazoles, ortho-cyclopropyl-carboxanilide derivatives, phenylpyrroles, and systemic fungicides. Examples of suitable additions of fungicidally active ingredients include, but are not limited to, the following compounds: azoxystrobin; sedaxane, bitertanol; carboxin; Cu₂O; cymoxanil; cyproconazole; cyprodinil; dichlofluamid; difenoconazole; diniconazole; epoxiconazole; fenpiclonil; fludioxonil; fluoxastrobin, fluquiconazole; flusilazole; flutriafol; furalaxyl; guazatin; hexaconazole; hymexazol; imazalil; imibenconazole; ipconazole; kresoxim-methyl; mancozeb; metalaxyl; mefenoxam; metconazole; myclobutanil, oxadixyl, pefurazoate; penconazole; pencycuron; prochloraz; propiconazole; pyroquilone; (±)-cis-1-(4-chlorophenyl)-2-(1H-1,2,4-triazol-1-ypcycloheptanol; spiroxamin; tebuconazole; thiabendazole; tolifluamide; triazoxide; triadimefon; triadimenol; trifloxystrobin, triflumizole; triticonazole and uniconazole. Particularly preferred fungicidally active agents include azoxystrobin, difenoconazole, fludioxonil, thiabendazole, tebuconazole, metalaxyl, mefenoxam, sedaxane, myclobutanil, fluoxastrobin, tritaxonazole, and trifloxystrobin.

Depending upon the particular plant propagation material to be treated, the conditions under which it is to be stored, and the soil and weather conditions under which it is expected to germinate and grow, the compositions of the present invention may include a wide spectrum of one or more additives. Such additives include, but are not limited to, uv-protectants, pigments, dyes, extenders such as flour, dispersing agents, excipients, anti-freezing agents, preservatives, herbicidal safeners, seed safeners, seed conditioners, micronutients, fertilizers, biocontrol agents, inoculants, surfactants, sequestering agents, plasticizers, colorants, brighteners, emulsifiers, flow agents such as calcium stearate, talc and vermiculite, coalescing agents, defoaming agents, humectants, thickeners, waxes, bactericides, insecticides, pesticides, and fillers such as cellulose, glass fibers, clay, kaolin, talc, pulverized tree bark (e.g., Douglas fir bark or alderbark), calcium carbonate and wood meal, and odor-modifying agents. Typical excipients include finely divided mineral substances such as pumice, attapulgite, bentonite, kaoline zeolite, diatomite, and other clays, modified diatomaceous adsorbents, charcoal, vermiculite, finely divided organic substances such as peat moss, wood powder, and the like. Such additives are commercially available and known in the art.

Typically, when a mixture of the components is prepared, either as tank-mixes, pre-mixes, dry dust-mixes, wettable powders, granules, soluable concentrates, emulsifyable concentrates, or flowable solutions, other formulation auxiliaries may also be used. Such formulation auxiliaries are known in the art.

What is claimed is:

1. A method for controlling or reducing Fusarium virguliforme, Fusarium brasiliense sp. nov., Fursarium cuneirostrum sp. nov., or Fusarium tucumaniae in plants comprising:
applying thiabendazole to a plant seed prior to planting, wherein said plant seed is infected with a fungal strain selected from Fusarium virguliforme, Fusarium brasiliense sp. nov., Fursarium cuneirostrum sp. nov., or Fusarium tucumaniae; and
planting said plant seed.

2. (canceled)

3. (canceled)

4. (canceled)

5. A method for suppressing, controlling, or reducing Sudden Death Syndrome in plants comprising:
applying thiabendazole to a plant seed prior to planting, wherein said plant seed contains a precursor to Sudden Death Syndrome; and
planting said plant seed.

6. (canceled)

7. (canceled)

8. (canceled)

9. A method for controlling or reducing Fusarium virguliforme, Fusarium brasiliense sp. nov., Fursarium cuneirostrum sp. nov., or Fusarium tucumaniae in plants comprising:
applying thiabendazole to the locus of a plant seed or to the soil where a plant seed has been, or will be, sown, and wherein said locus of the plant seed or the soil where the plant seed has been, or will be, sown, contains a fungal strain selected from Fusarium virguliforme, Fusarium brasiliense sp. nov., Fursarium cuneirostrum sp. nov., or Fusarium tucumaniae.

10. A method for reducing damage to a plant or plant seed caused by Fusarium virguliforme, Fusarium brasiliense sp. nov., Fursarium cuneirostrum sp. nov., or Fusarium tucumaniae comprising:
applying thiabendazole to the locus of a plant seed or to the soil where a plant seed has been, or will be, sown, and wherein said locus of the plant seed or the soil where the plant seed has been, or will be, sown, contains a fungal strain selected from Fusarium virguliforme, Fusarium brasiliense sp. nov., Fursarium cuneirostrum sp. nov., or Fusarium tucumaniae.

11. (canceled)

12. (canceled)

13. The method of claim 1 wherein said plant seed is a soybean seed.

14. The method of claim 1 wherein said plant seed exhibits a resistant trait to soybean sudden death syndrome.

15. The method according to claim 1, wherein the fungal strain is Fusarium virguliforme.

16. The method of claim 1 wherein said plant seed is susceptible to soybean sudden death syndrome.

17. The method according to claim 5, wherein the precursor is selected from Fusarium virguliforme, Fusarium brasiliense sp. nov., Fursarium cuneirostrum sp. nov., or Fusarium tucumaniae.
